(19) United States
(12) Patent Application Publication
(10) Pub. No.: US 2017/0011185 A1
(43) Pub. Date: Jan. 12, 2017

(54) ARTIFICIAL NEURAL NETWORK AND A METHOD FOR THE CLASSIFICATION OF MEDICAL IMAGE DATA RECORDS

(71) Applicant: Siemens Healthcare GmbH, Erlangen (DE)

(72) Inventor: Bernd Schweizer, Ketsch (DE)

(73) Assignee: Siemens Healthcare GmbH, Erlangen (DE)

(21) Appl. No.: 15/205,105

(22) Filed: Jul. 8, 2016

(30) Foreign Application Priority Data
Jul. 10, 2015 (DE) 102015212953.5

(51) Int. Cl. G06F 19/00

(52) U.S. Cl. CPC G06F 19/345; G06F 19/321; G06F 19/322

(57) ABSTRACT

In a method for the assignment of a metadata entry to a medical image data record, a computer executes a method for the assignment of the metadata entry to the medical image data record, and a method for the provision of a trained artificial neural network and the same or another computer executes a method for the provision of the trained artificial neural network.

### BACKGROUND OF THE INVENTION

Field of the Invention

The invention concerns a method for the assignment of a metadata entry to a medical image data record, a computer for the execution of the method for the assignment of the metadata entry to the medical image data record, a method for the provision of a trained artificial neural network, and a computer for the execution of the method for the provision of the trained artificial neural network.

Description of the Prior Art

Medical imaging devices, for example a magnetic resonance device, a single-photon emission tomography device (SPECT device), a positron emission tomography device (PET device), a computed tomography device, an ultrasound device, an X-ray device, a C-arm device, or a combined medical imaging device, which includes any combination of a plurality of said imaging modalities includes, are suitable for the generation of a medical image data record.

In this context, medical imaging devices typically generate large quantities of medical image data records. The efficient management and/or efficient further processing of these medical image data records, for example in a hospital, places requirements on the identification and/or classification of these medical image data records.

One known possibility for the classification of a medical image data record includes an evaluation of the metainformation assigned to the medical image data record. Metainformation allocated to the medical image data record typically includes at least one metadata class, wherein a plurality of metadata entries characterizing features of medical image data is assigned to each metadata class of the at least one metadata class.

To some extent, the metainformation is already allocated to the medical image data record and stored in a DICOM header and/or in the form of part strings of a series name of the medical image data record. However, in many practical cases, the classification of the medical image data record with reference to the metainformation contained in the DICOM header and/or in the series name is subject to limitations. For example, a search for anatomical information in the series name of the medical image data record is typically dependent on a naming convention used in the hospital and/or on the language of the country and/or on the type of scanner used and therefore often unreliable. Similarly, in some places a readout of metainformation from the DICOM header of the medical image data record may not be reliable because, for example, many entries in the DICOM header have not been filled in and/or so-called private DICOM tags are used which are dependent on the manufacturer and/or version.

### SUMMARY OF THE INVENTION

An object of the invention is to facilitate improved assignment of a metadata entry to a medical image data record or improved training of an artificial neural network.

The method according to the invention for the assignment of a metadata entry to a medical image data record includes the following steps.

A metadata class is defined that is composed of multiple metadata entries characterizing features of medical image data.

A medical image data record to be classified is provided to a trained artificial neural network.

Classification of the medical image data record using the trained artificial neural network takes place according to the image content of the medical image data record, with the classification of the medical image data record including, with respect to the metadata class, assigning one metadata entry among the multiple metadata entries to the medical image data record.

The multiple metadata entries that are grouped together to form the metadata class form metainformation, also known as metadata, containing information on features of the medical image data record. Accordingly, the metadata class forms a higher-ranking structure to which the multiple metadata entries are assigned. While the medical image data record can typically always be classified with respect to the metadata class, generally only one metadata entry out of the multiple metadata entries, sometimes also more than one metadata entry among the multiple metadata entries, characterizes features of the medical image data record appropriately. The classification of the medical image data record then takes place with respect to the metadata class such that at least one metadata entry among the multiple metadata entries belonging to the metadata class is assigned to the medical image data record. Accordingly, the metadata entries represent categories into which the medical image data record can be filed. Examples of possible metadata classes with associated metadata entries are described below.

Only one possible example is mentioned for elucidation: a metadata class selected is, for example, an orientation in which the medical image data record was recorded with respect to an object under examination. In this context, the metadata class ‘orientation’ has three metadata entries: ‘axial’, ‘coronal’ and ‘sagittal’. Accordingly, a classification of the medical image data record with respect to the metadata class ‘orientation’ will result in an assignment of one of the three metadata entries, i.e. ‘axial’, ‘coronal’ or ‘sagittal’, to the medical image data record. This consideration is based on the fact that the medical image data record is typically recorded with only one single orientation out of the three possible orientations.

An artificial neural network (ANN) is a network of artificial neurons simulated in a computer program. In this context, the artificial neural network is typically based on the networking of multiple artificial neurons. In this context, the artificial neurons are typically arranged on different layers. The artificial neural network usually includes an input layer and an output layer whose neuron output is the only visible layer in of the artificial neural network. Layers lying between the input layer and the output layer layers are typically referred to as hidden layers. Typically, initially an architecture and/or topology of an artificial neural network is initiated and then trained in a training phase for a special task or in a training phase for a plurality of tasks. In this context, the training of the artificial neural network typically includes a change to a weighting of a connection between two artificial neurons of the artificial neural network. The training of the artificial neural network can also include the development of new connections between artificial neurons, the deletion of existing connections between artificial neurons, the adaptation of threshold values for the artificial neurons and/or the addition or deletion of artificial neurons. This enables two different trained artificial neural networks to carry out different tasks even though they have the same architecture and/or topology, for example.

One example of an artificial neural network is a shallow artificial neural network, which often only contains one single hidden layer between the input layer and the output layer and is hence relatively easy to train. A further example is a deep artificial neural network (deep neural network) containing a plurality (for example up to ten) interleaved hidden layers of artificial neurons between the input layer and the output layer. In this context, the deep artificial neural network facilitates improved identification of patterns and complex relationships. It is also possible to select a convolutional deep artificial neural network for the classification task which additionally uses convolution filters, for example edge filters.

In accordance with the invention, the artificial neural network used for the classification of the medical image data record is one that has been trained such that it facilitates the assignment of the metadata entry to the medical image data record with respect to the metadata class. In this context, the trained artificial neural network can be trained for a special training task, for example it can be suitable only for the classification of the medical image data record with respect to one single metadata class. Then, in practice, typically different artificial neural networks are used in parallel to carry out the classifications according to different metadata classes. However, the trained artificial neural network can possibly also carry out the classifications with respect to different metadata classes simultaneously. In the present method, in particular a ready-trained artificial neural network is provided for the classification of the medical image data record. In this context, the training of the artificial neural network can be performed by a number of training medical image data records. Various possibilities for training the artificial neural network are described in one of the following sections. The artificial neural network can be trained by the method according to the invention for the provision of a trained artificial neural network as described below.

The acquisition of the medical image data record to be classified can include the recording of the medical image data record to be classified by means of a medical imaging device or the loading of the medical image data record to be classified from a database. The medical image data record to be classified is not as yet assigned any metadata entry and/or is possibly assigned a false metadata entry in particular with respect to the metadata class. The medical image data record to be classified has an image content which in particular includes a two-dimensional, three-dimensional or four-dimensional (in the case of time-series investigations) matrix of intensity values representing, for example, anatomical structures of an object under examination. The metadata entry assigned to the medical image data record during the classification can finally in particular be provided, i.e. output on an output unit and/or stored in a database, in particular as metainformation for the medical image data record, for example in a DICOM header of the medical image data record.

The classification of the medical image data record is performed exclusively on the basis of the image content of the medical image data record. This advantageously enables the classification of the medical image data record to take place independently of metainformation, which may possibly already be assigned to the medical image data record. In this way, the image content of the medical image data record can be fed into the trained artificial neural network as input information. The artificial neural network can then assign as output, in particular as output from the artificial neurons in the output layer, at least one metadata entry among the multiple metadata entries allocated to the metadata class, to the medical image data record. This procedure is based on the consideration that the metainformation can be read out via the medical image data record usually from the image content of the medical image data record. For example, just as a human observer is also to determine solely with reference to the image content of the medical image data record the imaging modality and/or orientation with which the medical image data record was recorded, which body region is depicted by the medical image data record or whether the image content of the medical image data record has artifacts, the correspondingly trained artificial neural network is also able to extract this information solely on the basis of the image content of the medical image data record.

The inventive method enables the classification of the medical image data record to be performed with a relatively generic approach using the trained artificial neural network. In this context, it is possible to make optimum utilization of the ability of the artificial neural network to abstract the image contents of the medical image data record. There is no need to use an algorithm tailor-made for an application, for example a feature detector specification designed for the classification with respect to the metadata class. Instead, it is only necessary for a trained artificial neural network, in particular with appropriate examples of images, to be provided for the classification. The inventive procedure enables a dictionary of metainformation on the medical image data record or on a number of medical image data records to be compiled automatically by means of the trained artificial neural network.

The classification of the medical image data record can be used for numerous applications which will be dealt with in more detail in one of the following sections. Examples of such applications are:
the initiation of automatic preprocessing steps in dependence on a type of image and/or body region under examination in the medical image data record,
the automatic arrangement of series of images in a post-processing of the medical image data record,
the identification of artifacts in the medical image data record,
the compilation of usage statistics, possibly covering different models of medical imaging devices,
the output of an instruction to a service engineer, possibly the initiation of remote service actions, etc.

In an embodiment of the method for the assignment of a metadata entry to a medical image data record, the metadata class is selected from the following list: a body region depicted in the medical image data record, an orientation of the medical image data record, an imaging modality by means of which the medical image data record is recorded, a protocol type by means of which the medical image data record is recorded, a type of image interference that occurs in the medical image data record. In this context, the metadata class body region can include as exemplary metadata entries different body regions of the object under examination. For example, conceivable metadata entries for the metadata class ‘body region’ are a head region, a chest region, an abdominal region, a leg region, etc. The metadata class ‘orientation’ in particular includes the metadata entries ‘axial’, ‘coronal’ and ‘sagittal’. The metadata class ‘imaging modality’ can include as metadata entries different possible medical imaging modalities, such as, for example, magnetic resonance imaging, computed tomography imaging, PET imaging, etc. The metadata class ‘protocol type’ can include different possible protocols by means of which the medical image data record can be recorded. In this context, possible protocols are, in particular in the field of magnetic resonance imaging, a spin echo protocol, a gradient echo protocol, etc. With magnetic resonance imaging, this enables classification with respect to the sequence type used to record the medical image data. In this context, the metadata class ‘image interference’ can include as a first metadata entry that there must be no image interference in the medical image data record. A second conceivable metadata entry in metadata class ‘image interference’ is that there must be image interference in the medical image data record. It is also conceivable for image interference that occurs specifically in the medical image data record, such as, for example, metal artifacts, clipped arms, etc., to form separate metadata entries. The metadata classes mentioned, which include the metadata entries mentioned, represent advantageous possibilities as to how the medical image data record can be classified in a particularly informative way. Further metadata classes with respect to which classification of the medical image data record can be performed by means of the artificial neural network are conceivable. It is also conceivable for the metadata classes mentioned to include still further possible metadata entries.

One embodiment of the method for the assignment of a metadata entry to a medical image data record provides that the medical image data record is displayed with reference to the metadata entry assigned to the medical image data record on a display interface of display unit. This automatically enables a display that is optimized to the metadata entry assigned to the medical image data record. For example, the artificial neural network can be used to identify an orientation of the medical image data record and to display the medical image data record with reference to the orientation. Particularly in the case of magnetic resonance imaging with which a high number of recorded medical image data records is available for one single object under examination, automatic classification by means of the artificial neural network can facilitate an optimized display of the medical image data records. For example, in the case of magnetic resonance imaging, the artificial neural network can automatically identify the orientation of the medical image data records and/or the presence of a contrast agent during the imaging and on the basis of this then display the medical image data records on the display unit. In this context, most suitable is a display with a number of display segments that are described in more detail below.

In an embodiment of the method for the assignment of a metadata entry to a medical image data record, the display interface includes a plurality of display segments, wherein one display segment among the multiple display segments is selected with reference to the metadata entry assigned to the medical image data record and the medical image data record is displayed in the selected display segment. This procedure is advantageous when a number of medical image data records to which different metadata entries were assigned is to be displayed on the display interface. In this context, a display segment can display a window in the display interface. Metadata entries can be defined for the display segments so that the only medical image data records displayed in the display segment are those to which the respective metadata entry was assigned. This enables a configuration of the display interface which facilitates a standardized display of the medical image data record in particular for different objects under examination. This enables the same display segments always to be filled with the same image information. The filling of the display segments with the appropriate medical image data records can advantageously be performed by means of the suggested procedure independently of a series name and/or metainformation in a DICOM header of the medical image data records. To this end, before display on the display interface, the medical image data records can be analyzed and classified by means of the trained artificial neural network exclusively with reference to their image information and then displayed with reference to the metadata entries assigned in the appropriate display segments.

In another embodiment of the method for the assignment of a metadata entry to a medical image data record, the display interface includes an input field for a user, wherein the medical image data record is displayed on the display interface with reference to a user input made by the user in the input field and to a comparison of the user input with the metadata entry assigned to the medical image data record. The user input can be, for example, a text input and the input field can be embodied as a text input field. The text input of the user can then be compared with a text string allocated to the metadata entry. Alternatively, the user input can also include a selection of the metadata entry from a selection menu. This enables the user to select medical image data records for display on the display interface particularly simply by means of the user entry. This in particular makes it possible to fill the display segments described in the preceding section with the appropriate medical image data records intuitively in accordance with the user's wishes. In this way, it is particularly easy for the user to define the display segments of display interface in which a specific type of medical image data records is to be displayed.

In another embodiment of the method for the assignment of a metadata entry to a medical image data record, a number of medical image data records are classified by the trained artificial neural network, wherein at least one metadata entry among the multiple metadata entries is in each case assigned to the number of medical image data records, and a statistical evaluation of the number of medical image data records is performed with reference to the metadata entries assigned to the number of medical image data records. In this context, an evaluation of a frequency of an assignment of specific metadata entries among the multiple metadata entries is particularly advantageous, as is described in more detail below. For example, the suggested procedure can be used automatically to evaluate a plurality of medical image data records for different questions exclusively with reference to their image content. The artificial neural network can be used to perform a classification of this kind, which enables the statistical evaluation of the metadata entries in a particularly simple and/or robust way. This enables a radiologist and/or hospital managers to be provided in particularly simple way with valuable indications of the capacity utilization of medical imaging devices and/or the achievement of a quality standard. New classification problems required for an evaluation can also be solved in a specific hospital by training with sufficient image material. Particularly advantageously, it is possible to dispense with the development of dedicated algorithms for each new classification problem. In this way, the implementation of an artificial neural network in a technical infrastructure in situ in a hospital can provide a flexible solution for new classification requirements.

In an embodiment of the method for the assignment of a metadata entry to a medical image data record, during the classification of the number of medical image data records, a first metadata entry is assigned to a first set with a first number of first medical image data records among the multiple medical image data records and a second metadata entry is assigned to a second set with a second number of second medical image data records among the multiple medical image data records, and the statistical evaluation includes comparison of the first number with the second number. In this way, the classification performed enables a comparison of two different classes of medical image data records to be performed in particularly simple manner. One exemplary evaluation is to compare a frequency of image recordings from adult patients with the frequency of image recordings from pediatric patients. To this end, the first number of first medical image data records, which were acquired from adult patients are compared with the second number of second medical image data records, which were acquired from pediatric patients.

In another embodiment of the method for the assignment of a metadata entry to a medical image data record, the metadata class includes the occurrence of a specific type of image interference, wherein the first metadata entry represents the occurrence of the specific type of image interference in the medical image data record and the second metadata entry represents the absence of the specific type of image interference in the medical image data record. User information for a user is compiled with reference to the comparison of the first number with the second number. This enables particularly informative information to be compiled as to how often the specific type of image interference, also called artifacts, occurs in the medical image data records. For example, this enables the frequency of recordings on which the object under examination is depicted with clipped arms to be determined. As a further example, it is possible to determine a frequency of medical image data records with an inhomogeneous signal intensity, in particular an inhomogeneous magnetic resonance signal intensity. In this way, it is also possible to analyze the frequency of occurrence of motion artifacts and metal artifacts in the medical image data records. Other types of image interference that can be evaluated in this way are also conceivable. In this context, the use of the artificial neural network for the identification of the image interference is particularly advantageous because the information on image interference is typically not encoded of metainformation already assigned to the medical image data record, for example not in the DICOM header and/or in the series name. The output information for the user is in particular then compiled when the comparative value for the first number with the second number exceeds a specific threshold value. Since the increased occurrence of artifacts can be indicative of a sub-optimum operation of the medical imaging device and/or of a technical deterioration or a defect in components of the medical imaging device, one of the types of output information for the user listed in the following is particularly advantageous: an instruction to the user to use a different recording protocol, an instruction to an application specialist that customer training is advisable, an instruction to the sales department that optional additional packets for the customer could enable the avoidance of artifacts, an instruction to the service department that the image quality has deteriorated, optionally with the automatic transfer of the most distinctive examples of images. The appropriate output information can be selected in accordance with the frequency, course and options for the rectification of the image interference. Obviously, further types of output information are also conceivable.

In another embodiment of the method for the assignment of a metadata entry to a medical image data record, the provision of the trained artificial neural network takes place according to the method according to the invention for the provision of a trained artificial neural network. This enables the provision of a particularly advantageously trained artificial neural network for the classification task.

The computer according to the invention for the assignment of a metadata entry to a medical image data record includes a definition unit, a provisioning unit, an acquisition unit and a classification unit. The computer is configured to execute a method according to the invention for the assignment of a metadata entry to a medical image data record.

In this context, the definition unit is designed for the definition of a metadata class including a number of metadata entries characterizing features of medical image data. The provisioning unit is designed for the provision of a trained artificial neural network. The acquisition unit is designed for the acquisition of a medical image data record to be classified. The classification unit is designed for the classification of the medical image data record using the trained artificial neural network according to an image content of the medical image data record, wherein the classification of the medical image data record includes the fact that, with respect to the metadata class, one metadata among of the multiple metadata entries is assigned to medical image data record.

The advantages of this computer according to the invention substantially correspond to the advantages of the method according to the invention for the assignment of a metadata entry to a medical image data record, which are explained above in detail. All features, advantages or alternative embodiments mentioned above are applicable to the computer as well. In this context, the corresponding functional features of the method can be embodied by substantive modules, in particular by hardware modules.

The method according to the invention for the provision of a trained artificial neural network includes the following steps.

A metadata class is defined that is composed of metadata entries characterizing features of medical image data. A number of training medical image data records are provided. Metadata entries with respect to the metadata class are assigned to the multiple training medical image data records. An artificial neural network is trained using an image content of the multiple training medical image data records and the metadata entries assigned to the multiple training medical image data records, wherein the trained artificial neural network facilitates an assignment of a metadata entry to a medical image data record. The trained artificial neural network is provided for the classification of a medical image data record.

Therefore, the decisive factor for the training of the artificial neural network is the image content of the plurality of training medical image data records to which the associated metadata entries are assigned in each case with respect to the metadata class. In this context, the training medical image data records can be formed from medical image data records that have already been recorded by means of medical imaging devices, possibly made by different manufacturers. The assignment of the metadata entries to the plurality of training medical image data records is in particular performed manually or semi-automatically, advantageously as described one of the following sections. In this context, the assignment of the metadata entries to the plurality of training medical image data records can, for example, be performed by a manufacturer of the medical imaging device and/or the classification software or by a member of the hospital staff.

Following the assignment of the metadata entries to the plurality of training medical image data records, the plurality of training medical image data records represent so-called labeled training medical image data records. In this context, labeled means that each training medical image data record is provided with the anticipated classification, i.e. the metadata entry associated with the training medical image data record with respect to the metadata class, as a label.

The training of the artificial neural network is advantageously performed by back propagation. This means that the image content of the multiple training medical image data records are fed into the artificial neural network to be trained as input data. During the training, an output of the artificial neural network to be trained is compared with the metadata entries (the labels) assigned to the multiple medical image data records. The training of the artificial neural network then includes a change to the network parameters of the artificial neural network to be trained such that the output of the artificial neural network to be trained is closer to the metadata entries assigned to the multiple medical image data records. This advantageously enables the artificial neural network to be trained such that it assigns the appropriate labels to the image content of the multiple medical image data records. Although back propagation is the most important training algorithm for training the artificial neural network, it is also possible for other algorithms known to those skilled in the art to be used to train the artificial neural network. Examples of other possible algorithms are evolutionary algorithms, “simulated annealing”, “expectation maximization” algorithms (EM algorithms), parameter-free algorithms (non-parametric methods), particle swarm optimization (PSO), etc.

The training of the artificial neural network can take place entirely at the premises of the manufacturer of the medical imaging device and/or the classification software. Alternatively, it is also conceivable for pre-training to be provided at the premises of the manufacturer of the medical imaging device and/or the classification software and post-training to be arranged on a one-off or multiple basis in a hospital in order to structure the corresponding image classification more robustly specifically for the hospital's requirements. It is also conceivable to re-designate a ready-trained artificial neural network by feeding in new weighting matrices for another classification task. It is also conceivable for the training of the artificial neural network to take place in a number of iterations. This enables an assignment of the metadata entries to the plurality of training medical image data records and the training of the artificial neural network to take place in a plurality of alternating steps. For example, selectivity during the classification of the medical image data record can be improved by means of the trained artificial neural network.

The artificial neural network trained in this way can then be used in a method according to the invention for the assignment of a metadata entry to a medical image data record as described in one of the preceding sections. In this way, the described training of the artificial neural network enables a subsequently particularly advantageous classification of medical image data records with which the associated metadata entries are not yet known in advance.

In an embodiment of the method for the provision of a trained artificial neural network, the training of the artificial neural network includes a change of this kind to network parameters of the artificial neural network such that, when the trained artificial neural network is applied to the image content of the plurality of training medical image data records, the artificial neural network allocates the metadata entries assigned to a plurality of training medical image data records to the plurality of training medical image data records. In this context, the back propagation procedure described here provides a particularly advantageous possibility for training the artificial neural network. In this way, the artificial neural network can be trained flexibly for different classification tasks in dependence on the training medical image data records provided and the metadata entries assigned.

One embodiment of the method for the provision of a trained artificial neural network provides that, prior to the provision of the trained artificial neural network, the validity of the trained artificial neural network is checked, wherein, for the checking of the validity of the artificial neural network, metadata entries are determined for a part of the training medical image data records by the trained artificial neural network and the metadata entries determined in this way are compared to the metadata entries assigned to the part of training medical image data records. This checking enables it to be ensured that the trained artificial neural network is suitable for the classification of medical image data records with which the actual metadata entry is unknown in advance.

One embodiment of the method for the provision of a trained artificial neural network provides that the part of the medical image data records is excluded during the training of the artificial neural network. This procedure enables an improvement in the checking of the validity to be achieved since the training medical image data records used for the training are not actually used for the checking. This particularly advantageously avoids falsification of the checking of the validity.

In an embodiment of the method for the provision of a trained artificial neural network, the training of the artificial neural network includes a first training step and a second training step, wherein during the first training step, the artificial neural network is only trained on the basis of the image content of the plurality of training medical image data records by means of unsupervised learning and, during the second training step, the training in the artificial neural network performed in the first training step is refined using the metadata entries assigned to the plurality of training medical image data records. Unsupervised learning is in particular a special form of machine learning with which, generally without further instructions from outside, a computing system attempts to determine structures in unstructured data. Unsupervised learning enables the artificial neural network to be trained without using the metadata entries assigned to the plurality of training medical image data records in the first training step. In this first training step, the artificial neural network is able of its own accord, without any external procedure, to identify structures in the multiple training medical image data records. In the second training step, it is then possible for the structures determined in the first training step to be filled with the corresponding metadata entries. Since in the training step the pre-training is performed by means of unsupervised learning, the database of training medical image data records can possibly be selected as smaller for the second training step. Hence, the two-stage procedure can represent an efficient possibility for the training of the artificial neural network.

Since the training of the artificial neural network takes place using the metadata entries assigned to the plurality of training medical image data records, the metadata entries must be assigned to the training medical image data records. In this context, it is possible, for example, to use existing databases of training medical image data records. However, for many of the classification tasks, it is necessary to compile a training database including the training medical image data records and the assigned metadata entries. The assignment of the metadata entries to the plurality of training medical image data records can also take place by a user input. However, particularly with a high number of training medical image data records, this procedure can be very time-consuming. Alternatively, the assignment of the metadata entries to the plurality of training medical image data records can take place by means of the extraction of the metadata entries from a DICOM header of the training medical image data records. This procedure is advantageous for testing the trained artificial neural network. Different semi-automatic, possibilities for the assignment of the appropriate metadata entries to the training medical image data records are described below. In this context, the possibilities can be used separately of one another or in combination. Further procedures that appear appropriate to those skilled in the art are also conceivable for compiling the training database.

In an embodiment of the method for the provision of a trained artificial neural network, the assignment of the metadata entries to the multiple training medical image data records includes a preprocessing step in which the plurality of training medical image data records are processed by means of unsupervised learning. Unsupervised learning in the preprocessing step should enable typical structures to be recognized in the plurality of training medical image data records, in particular in an image content of the plurality of medical training image data records. In the preprocessing step, as data mining technology, unsupervised learning can support the assignment of the metadata entries to the plurality of training medical image data records particularly effectively. In particular, the preprocessing step serve as preparation for the manual assignment of the metadata entries by a user as will be described in more detail below. Hence, the use of unsupervised learning can particularly advantageously assist a user in the assignment of the metadata entries to the multiple training medical image data records.

In another embodiment of the method for the provision of a trained artificial neural network, the unsupervised learning includes the use of self-organizing-maps (SOM) method and/or a t-stochastic neighborhood embedding (t-SNE) method. The self-organizing-maps method is a method for displaying data properties in small dimensions in the form of a map. The map then represents an abstracted display of the input data, which may be a rectangular display, and can provide an overview of a structure in the input data. In this context, the self-organizing-maps method can work as an unsupervised learning method based on larger unclassified data volumes. The t-stochastic neighborhood embedding method also represents a modern clustering method, which transforms high-dimensional data volumes into low-dimensional cluster images (maps). The t-stochastic neighborhood embedding method can also perform the clustering of the data volumes with reference to structures in the data volumes. The self-organizing-maps method and the t-stochastic neighborhood embedding method are known to those skilled in the art and so they need not be described herein. The self-organizing-maps method and the t-stochastic neighborhood embedding method represent particularly advantageous data mining technologies, which are able to process a large amount of training medical image data records in the preprocessing step. With the t-stochastic neighborhood embedding method, it is possible to use another direction of projection, for example a 3D map after 2D, in order to increase the selectivity of this method. The methods mentioned can in particular prepare the plurality of training medical image data records particularly advantageously for the manual assignment of metadata entries by a user, as described in more detail below.

In another embodiment of the method for the provision of a trained artificial neural network, the training medical image data records preprocessed in the preprocessing step are displayed to a user in the form of a map, wherein the user assigns the metadata entries to the multiple training medical image data records by interaction with the map. The map includes a pictorial and/or abstracted display of the plurality of training medical image data records. The plurality of training medical image data records are advantageously displayed on the map grouped according to the preprocessing performed by unsupervised learning in the preprocessing step. In this context, the map can be embodied as two-dimensional or three-dimensional. The map is advantageously displayed to the user on a graphical user interface. The user can advantageously use tools to inspect the map displayed, for example to obtain an enlarged display of individual training medical image data records. For example, a data cursor conceivable so that the user is able to view the associated training medical image data record in a separate window by clicking on a point of the map. In this way, the structures in the image content of the plurality of training medical image data records identified by means of the unsupervised learning can be displayed particularly clearly to the user. As described in more detail below, the user can then perform a particularly efficient allocation of metadata entries to the plurality of training medical image data records on the map. In this context, particularly advantageously the methods described in the preceding section are used for preprocessing the plurality of training medical image data records for the display in the form of the map. The self-organizing-maps method and the t-stochastic neighborhood embedding method can namely include said map as a result.

In an embodiment of the method for the provision of a trained artificial neural network, the user assigns the metadata entries to the plurality of training medical image data records on the map displayed by a graphical segmentation tool. In this context, in one particularly advantageous procedure, the user uses graphical segmentation tools to mark on the map regions with associated training medical image data records to which in particular the same metadata entry is to be assigned. In this context, different types of segmentation tools, such as, for example, a lasso tool, are conceivable for the user interaction. It is then possible for a desired metadata entry to be assigned to all training medical image data records located in the selected region. This particularly efficiently enables a number of training medical image data records to be preprocessed simultaneously for the training of the artificial neural network.

It is also conceivable for the self-organizing-maps method to perform a direct assignment of the metadata entries to the plurality of training medical image data records in that the method checks. To this end, a training medical image data record can be applied to the input layer of the self-organizing maps and in the output layer, a node with the highest activation determined, i.e. calculated, where the training medical image data record is filed. If this node lies within a region of the map which is assigned to a specific metadata entry, the corresponding metadata entry can be automatically assigned to the training medical image data record.

The computer according to the invention for the provision of a trained artificial neural network includes a definition unit, a first provisioning unit, an assignment unit, a training unit and a second provisioning unit, wherein the second computer is configured to execute a method according to the invention for the provision of a trained artificial neural network.

In this context, the definition unit is designed for the definition of a metadata class comprising a plurality of metadata entries characterizing features of medical image data. The first provisioning unit is designed for the provision of a number of training medical image data records. The assignment unit is designed for the assignment of metadata entries with respect to the metadata class to the plurality of training medical image data records. The training unit is designed for the training of an artificial neural network using an image content of the multiple training medical image data records and the metadata entries assigned to the multiple training medical image data records, wherein the trained artificial neural network facilitates an assignment of a metadata entry to a medical image data record. The second provisioning unit is designed for the provision of the trained artificial neural network for the classification of a medical image data record.

The advantages of this computer according to the invention substantially correspond to the advantages of the method according to the invention for the provision of a trained artificial neural network, as described in detail above. All features, advantages or alternative embodiments mentioned above are applicable to this computer as well. The functional features of the method can be embodied by corresponding substantive modules, in particular by hardware modules in this computer.

The invention also encompasses a combined method for the provision of a trained artificial neural network and for the subsequent assignment of a metadata entry to a medical image data record using the trained artificial neural network provided. This combined method of this kind has the following steps.

A metadata class is defined that is composed of multiple metadata entries characterizing features of medical image data.

A number of training medical image data records are provided to a computer and metadata entries with respect to the metadata class are assigned to the multiple training medical image data records.

Training of an artificial neural network takes place using an image content of the multiple training medical image data records and the metadata entries assigned to the multiple training medical image data records, so the trained artificial neural network facilitates the assignment of a metadata entry to a medical image data record.

The trained artificial neural network is used for the classification of a medical image data record that has been acquired.

The classification of the medical image data record using the trained artificial neural network takes place according to the image content of the medical image data record, wherein the classification of the medical image data record includes, with respect to the metadata class, assigning one metadata entry among the multiple metadata entries to the medical image data record.

Further features, advantages or alternative embodiments of the method according to the invention for the assignment of a metadata entry to a medical image data record and/or of the method according to the invention for the provision of a trained artificial neural network are applicable to the combined method.

### BRIEF DESCRIPTION OF THE DRAWINGS

FIG. 1 shows a computer according to the invention in a first embodiment.

FIG. 2 shows a first embodiment of a method according to the invention for the assignment of a metadata entry to a medical image data record.

FIG. 3 shows a second embodiment of a method according to the invention for the assignment of a metadata entry to a medical image data record.

FIG. 4 shows a computer according to the invention in a second embodiment.

FIG. 5 shows a first embodiment of a method according to the invention for the provision of a trained artificial neural network.

FIG. 6 shows a second embodiment of a method according to the invention for the provision of a trained artificial neural network.

FIG. 7 shows an exemplary map, generated by a self-organizing-maps method.

FIG. 8 shows an exemplary map generated by a t-stochastic neighborhood embedding method.

### DESCRIPTION OF THE PREFERRED EMBODIMENTS

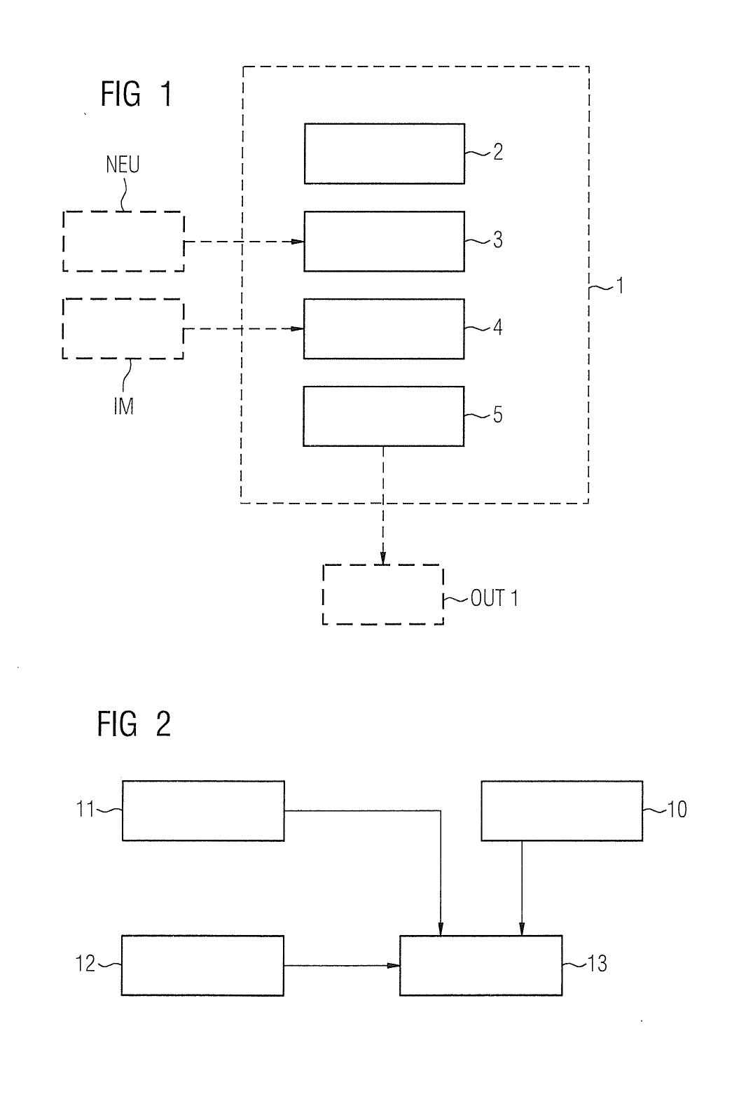

FIG. 1 shows a first computer 1 according to the invention. The first computer 1 includes a definition unit 2, a provisioning unit 3, an acquisition unit 4 and a classification unit 5. In this context, the definition unit 2, provisioning unit 3, acquisition unit 4 and the classification unit 5 can be embodied as processor units and/or computer modules and can in each case comprise interfaces to an input or output module, for example a keyboard or a monitor.

The provisioning unit 3 is connected to a first database NEU on which a trained artificial neural network is stored so that it can be retrieved by the provisioning unit 3. The acquisition unit 4 is connected to an image input interface IM, such as a second database and/or an imaging system so that the acquisition unit 4 of the image input interface IM is able to acquire the medical image data record to be classified. The classification unit 5 is connected to an output interface OUT1, for example a database and/or a monitor, so that the assignment of the metadata entry to the medical image data record can be provided, i.e. can be stored in the database and/or output on the monitor for a user.

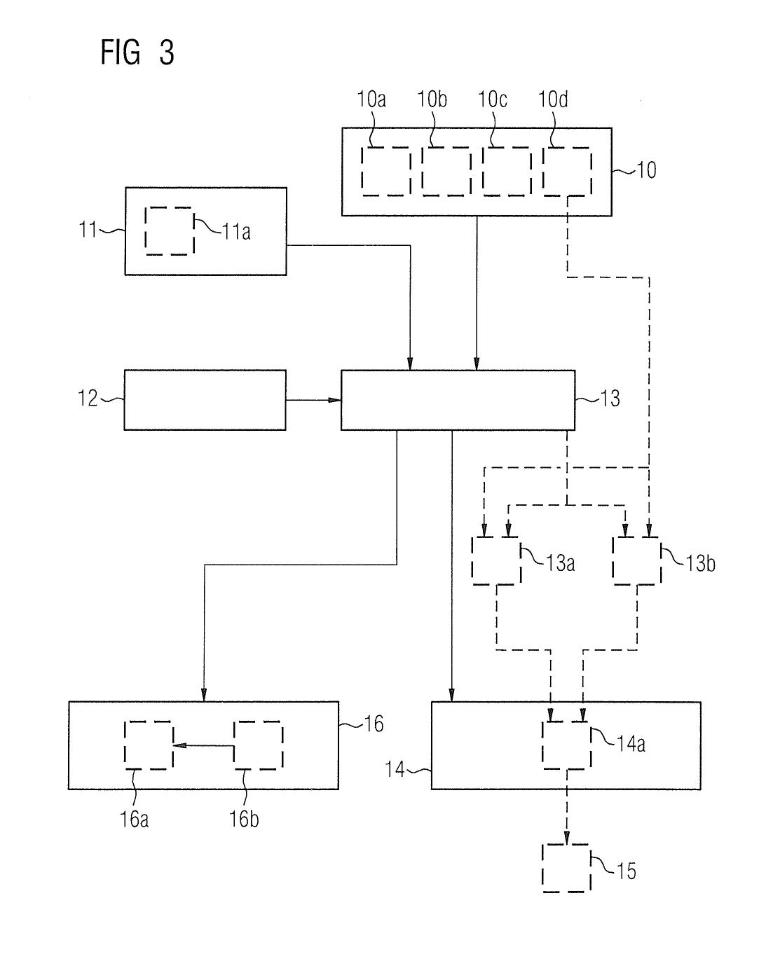

Hence, the first computer 1 together with the definition unit 2, provisioning unit 3, acquisition unit 4 and the classification unit 5 is embodied to execute a method for the assignment of a metadata entry to a medical image data record, such as is, for example, depicted in FIG. 2 or FIG. 3.

FIG. 2 shows a first embodiment of a method according to the invention for the assignment of a metadata entry to a medical image data record.

In a first method step 10, a metadata class has a number of metadata entries characterizing features of medical image data is defined by means of the definition unit 2. In a further method step 11, a trained artificial neural network is provided by means of the provisioning unit 3. In a further method step 12, a medical image data record to be classified is acquired by means of the acquisition unit 4. In a further method step 13, the medical image data record is classified using the trained artificial neural network according to an image content of the medical image data record by means of the classification unit 5, wherein the classification of the medical image data record includes the fact that, with respect to the metadata class, one metadata entry out of the plurality of metadata entries is assigned to the medical image data record.

FIG. 3 shows a second embodiment of a method according to the invention for the assignment of a metadata entry to a medical image data record.

The following description is substantially restricted to the differences from the exemplary embodiment in FIG. 2, wherein, with respect to identical method steps, reference is made to the description of the exemplary embodiment in FIG. 2. Substantially identical method steps are generally given the same reference numbers.

The second embodiment of the method according to the invention shown in FIG. 3 substantially includes the method steps 10, 11, 12, 13 of the first embodiment of the method according to the invention as shown in FIG. 2. In addition, the second embodiment of the method according to the invention includes the additional method steps and/or substeps shown in FIG. 3. Also conceivable is an alternative procedure to that in FIG. 3, which only comprises a part of the additional method steps and/or substeps depicted in FIG. 3. Obviously an alternative procedure to that in FIG. 3 can also comprise additional method steps and/or substeps.

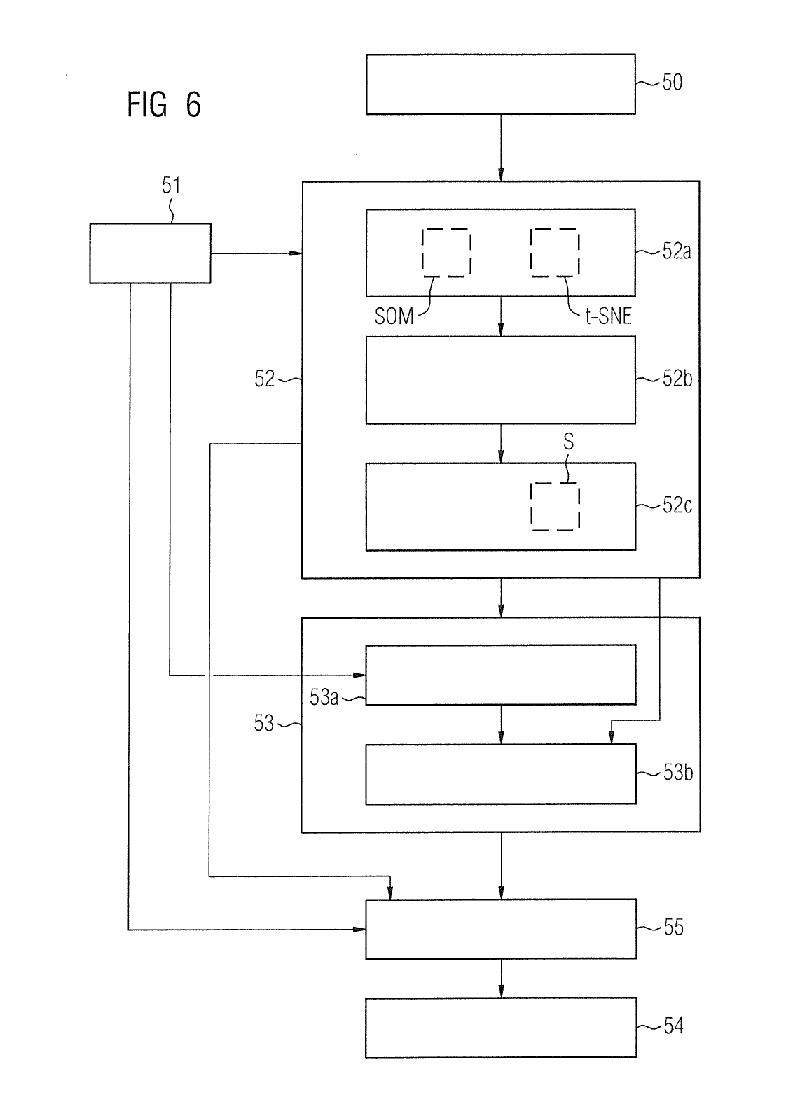

In the case shown in FIG. 3, the definition of the metadata class in the further method step 10 includes a selection of the metadata class. In this context, the metadata class can, for example, be selected in a first optional step 10a of the further method step 10 as a body region, which is depicted in the medical image data record. In a further optional step 10b of the further method step 10, the metadata class can also for example, be selected as an orientation of the medical image data record. In a further optional step 10c of the further method step 10, the metadata class can also be selected, for example, as an imaging modality by means of which the medical image data record is recorded. In a further optional step 10d of the further method step 10, the metadata class can also be selected as a protocol type by means of which the medical image data record is recorded. It is also conceivable for the metadata class to be selected in a further optional step 10e of the further method step 10 as a type of image interference that occurs in the medical image data record. The provision of the trained artificial neural network in the further method step 11 can include a number of steps 11a as are described in the method according to the invention for the provision of a trained artificial neural network (see FIG. 5-FIG. 6).

The classification of the medical image data record in the further method step 13 can have various applications, two of which are shown by way of example in FIG. 3. In this context, the two applications can be used separately of one another or in combination. Obviously, further possible applications of the classification of the medical image data record are also conceivable.

The first exemplary application includes the fact that, in a further method step 16, the medical image data record is displayed with reference to the metadata entry assigned to the medical image data record on a display interface of display unit. In this context, the display interface can include a plurality of display segments, wherein, in a second substep 16b of the further method step 16, a display segment of the plurality of display segments is selected with reference to the metadata entry assigned to the medical image data record and the medical image data record is displayed in the selected display segment.

In this context, the display interface can include an input field for a user, wherein the medical image data record is displayed on the display interface in a first partial step 16a of the further method step 16 with reference to a user input made by the user in the input field and to a comparison of the user input with the metadata entry assigned to the medical image data record. For example, this enables the appropriate display segment for the medical image data record to be selected in dependence on the user input.

The second exemplary application includes the fact that a plurality of medical image data records is classified by means of the trained artificial neural network, wherein at least one metadata entry out of the number of metadata entries is assigned to the plurality of medical image data records, wherein, in a further method step 14, a statistical evaluation of the plurality of medical image data records takes place with reference to the metadata entries assigned to the plurality of medical image data records.

To this end, during the classification of the plurality of medical image data records, in a further method step 13a, a first metadata entry can be assigned to a first quantity with a first number of first medical image data records out of the plurality of medical image data records and, in a further method step 13b, a second metadata entry can be assigned to a second quantity with a second number of second medical image data records out of the number of medical image data records. This enables the statistical evaluation of the plurality of medical image data records in the further method step 14 to include a comparison of the first number with the second number in a partial step 14a of the further method step 14.

For example, the metadata class includes the occurrence of a specific type of image interference, wherein the first metadata entry represents the occurrence of the specific type of image interference in the medical image data record and the second metadata entry represents the absence of the specific type of image interference in the medical image data record. It is then particularly advantageously possible in a further method step 15 to compile output information for a user with reference to the comparison of the first number with the second number.

The method steps depicted in FIG. 2-3 are executed by the first computer 1. To this end, the first computer 1 includes the necessary software and/or computer programs, which are stored in a memory unit of the first computer 1 stored. The software and/or computer programs include programming means designed to execute the method according to the invention when the computer program and/or the software is executed in the first computer 1 by means of a processor unit of the first computer 1.

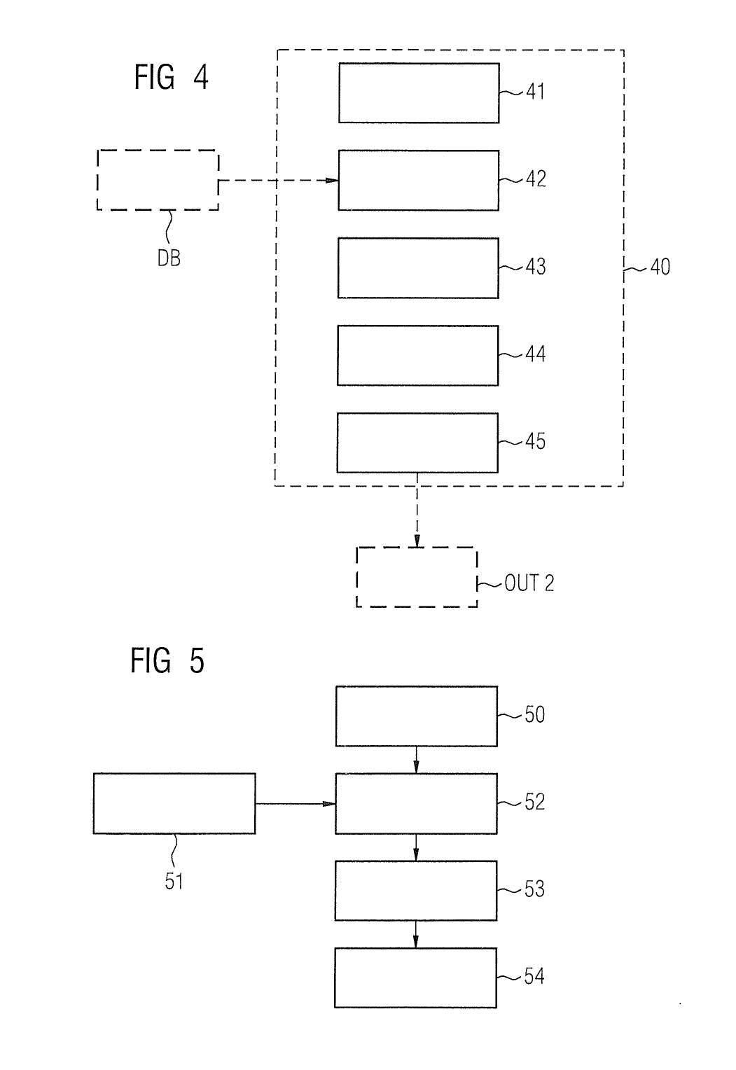

FIG. 4 shows a second computer 40 according to the invention. The second computer 40 includes a definition unit 41, a first provisioning unit 42, an assignment unit 43, a training unit 44 and a second provisioning unit 45. In this context, the definition unit 41, first provisioning unit 42, assignment unit 43, training unit 44 and second provisioning unit 45 can be embodied as processor units and/or computer modules and can in each case have interfaces to an input or output module, for example a keyboard or a monitor.

In particular, the first provisioning unit 42 includes an interface to a training image database DB from which the first provisioning unit 42 can retrieve the number of training medical image data records for the training of the artificial neural network. The second provisioning unit 45 includes a connection to an output interface OUT2 so that the trained artificial neural network can be provided. This enables the trained artificial neural network to be stored in a database so that it can be provided for the classification of medical image data records.

This enables the second computer 2 together with the definition unit 41, first provisioning unit 42, assignment unit 43, training unit 44 and second provisioning unit 45 embodied to execute a method for the provision of a trained artificial neural network, such as is, for example, depicted in FIG. 5 or in FIG. 6.

FIG. 5 shows a first embodiment of a method according to the invention for the provision of a trained artificial neural network.

In a first method step 50, a metadata class comprising a plurality of metadata entries characterizing features of medical image data is defined by the definition unit 41. In a further method step 51, a number of training medical image data records is provided by means of the first provisioning unit 42. In a further method step 52, metadata entries are assigned with respect to the metadata class to the plurality of training medical image data records by means of the assignment unit 43.

In a further method step 53, an artificial neural network is trained by the training unit 44 using an image content of the number of training medical image data records and the metadata entries assigned to the number of training medical image data records, wherein the trained artificial neural network facilitates the assignment of a metadata entry to a medical image data record. In this context, the training of the artificial neural network can include a change of this kind to network parameters of the artificial neural network such that, in the case of an application of the trained artificial neural network to the image content of the number of training medical image data records, the artificial neural network allocates the metadata entries assigned to the plurality of training medical image data records to the number of training medical image data records.

In a further method step 54, the trained artificial neural network is provided by the second provisioning unit 45 for the classification of a medical image data record.

FIG. 6 shows a second embodiment of a method according to the invention for the provision of a trained artificial neural network.

The following description is substantially restricted to the differences from the embodiment in FIG. 5, wherein, with respect to identical method steps, reference is made to the description of the exemplary embodiment in FIG. 5. Substantially identical method steps are generally given the same reference numbers.

The second embodiment of the method according to the invention shown in FIG. 6 substantially includes the method steps 50, 51, 52, 53, 54 of the first embodiment of the method according to the invention as shown in FIG. 5. In addition, the second embodiment of the method according to the invention shown in FIG. 6 includes additional method steps and/or substeps. Also conceivable is an alternative procedure to FIG. 6, which only comprises a part of the additional method steps and/or substeps depicted in FIG. 6. An alternative procedure to that in FIG. 6 can also have additional method steps and/or substeps.

In the case shown, the training of the artificial neural network in the further method step 53 includes a first training step 53a and a second training step 53b, wherein, during the first training step 53a, the artificial neural network is only trained on the basis of the image content of the number of training medical image data records by means of unsupervised learning and, during the second training step 53b, the training of the artificial neural network performed in the first training step 53a is refined using metadata entries assigned to the number of training medical image data records.

Prior to the provision of the trained artificial neural network, in the case shown in FIG. 6, in a further method step 55 the validity of the trained artificial neural network is checked, wherein, for the checking of the validity of the artificial neural network for part of the training medical image data records by the trained artificial neural network, metadata entries are determined and the metadata entries determined in this way are compared to metadata entries assigned to the part of the training medical image data records. In this context, the part of the medical image data records can be excluded during the training of the artificial neural network.

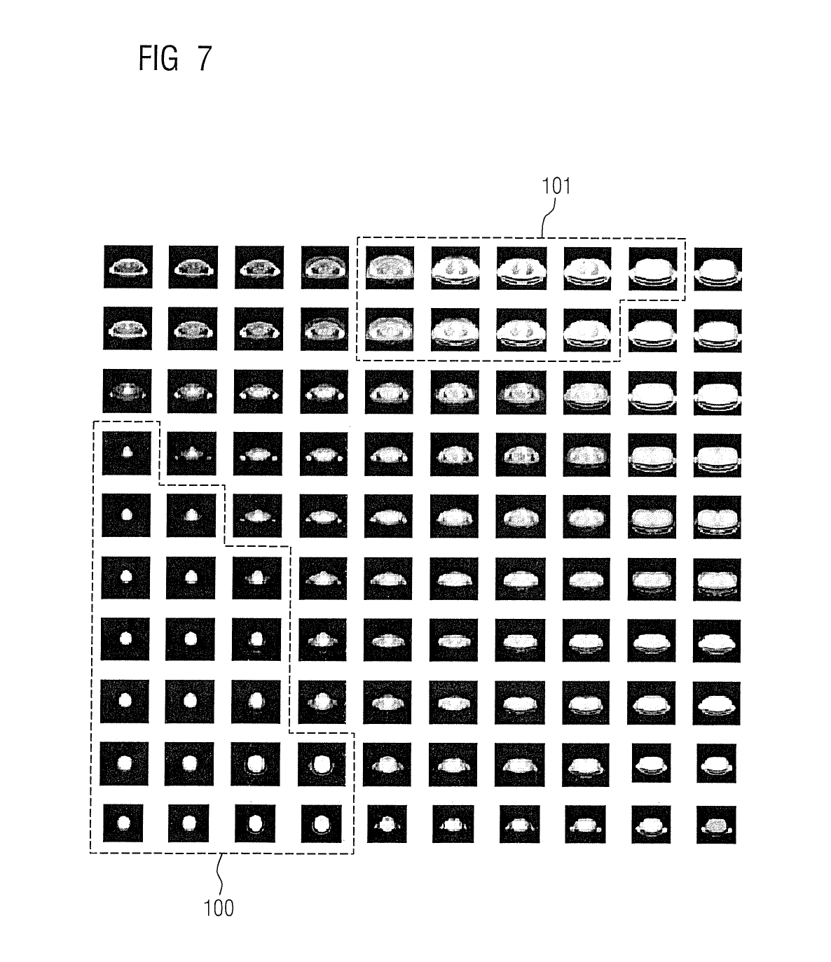

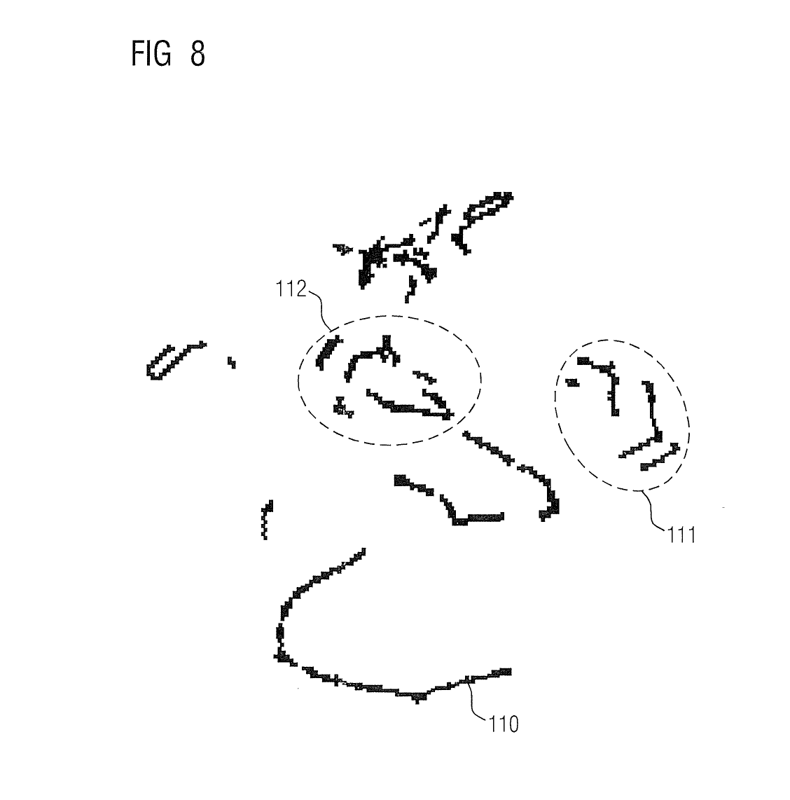

FIG. 6 also shows a particularly advantageous method for the assignment of the metadata entries to the number of training medical image data records in the further method step 52. Illustrations of this procedure can be found in FIGS. 7-8. These depict the embodiment of the further method step 52 shown in FIG. 6 as an example. Further procedures for the assignment of the metadata entries are conceivable. For the training of the artificial neural network, it is also possible to use a database in which training medical image data records to which associated metadata entries have already been assigned are stored.

In the case shown in FIG. 6, the assignment of the metadata entries to the plurality of training medical image data records includes a preprocessing step 52a in which the plurality of training medical image data records are processed by means of unsupervised learning. The unsupervised learning can for example include the use of a self-organizing-maps (SOM) method and/or a t-stochastic neighborhood embedding (t-SNE) method.

The training medical image data records preprocessed in the preprocessing step can be displayed to a user in a further partial step 52b of the further method step 52 in the form of a map. The user can then, in a further partial step 52c of the further method step 52, assign the metadata entries to the number of training medical image data records by means of interaction with the map. In this context, the user can, for example, perform the assignment on the map by means of a graphical segmentation tool S.

The method steps shown in FIG. 5-6 are executed by the second computer 40. To this end, the second computer 40 includes the necessary software and/or computer programs, which are stored in a memory unit of the second computer 40. The software and/or computer programs include programming means designed to execute the method according to the invention when the computer program and/or the software are executed in the second computer 40 by means of a processor unit of the second computer 40.

FIG. 7 shows an exemplary map, which has been generated by means of a self-organizing-maps method. In this context, the self-organizing-maps method has automatically arranged the training image data sets, which include non-attenuation corrected PET images, MR images and CT images, with respect to two metadata classes.

In the case shown, the first metadata class, with respect to which the self-organizing-maps method has grouped the training medical image data records, is an imaging modality by means of which the training medical image data records have been recorded. In the case shown, the second metadata class, with respect to which the self-organizing-maps method has grouped the training medical image data records is a body region depicted by the training medical image data records.

In this way, the map depicted, which in this exemplary case includes 10×10 output nodes, shows an arrangement of the plurality of training medical image data records both with respect to the imaging modality and with respect to the body region. For example, the non-attenuated corrected PET images are arranged at the top left of the map shown. The bottom left of the map shown contains depictions of a head region. Lung slices which were recorded by means of CT imaging are arranged in the middle of the map shown.

The user can now use suitable tools, for example graphical segmentation tools, to process the map. Advantageously, the user selects regions containing training medical image data records to which the same metadata entry is to be assigned. To this end, the user can use a lasso tool as an exemplary graphical segmentation tool. For example, in the case shown in FIG. 7, the user has selected the depictions of the head in a first segmentation 100. The metadata entry “Head region” with respect to the metadata class “Body region depicted by the training medical image data record” can then be assigned to the training medical image data records, which the self-organizing-maps method has arranged in the first segmentation 100. In the case shown in FIG. 8, the user has also selected MR images depicting the lungs in a second segmentation 101. The metadata entry “Thorax” with respect to the metadata class “Body region, which is depicted by the training medical image data record” and the metadata entry “Magnetic resonance imaging” with respect to the metadata class “Imaging modality by means of which the training medical image data record was recorded” can then be simultaneously assigned to the training medical image data records which the self-organizing-maps method has arranged in the second segmentation 1001.

FIG. 8 shows an exemplary map, which was generated by a t-stochastic neighborhood embedding method.

In this exemplary case, a number of image slices of training medical image data records, which were recorded by means of CT imaging, PET imaging or MR imaging are processed by means of the t-stochastic neighborhood embedding method. In this context, the snake-like structures depicted shown sequential image slices of an image volume.

It is now possible for the user to use a data cursor to inspect the image data lying behind the points in order to find out which structures belong to which imaging modality. The user can then, for example again by a lasso tool, assign particularly efficient metadata entries with respect to the metadata class “Imaging modality by which the training medical image data record was recorded”.

In the case shown, the user has, for example, selected the PET image data in two segmentations 111, 112 in the map shown. The metadata entry “PET imaging” with respect to the metadata class “Imaging modality by means of which the training medical image data record was recorded” can then be assigned to all medical training image set sets contained in the two segmentations 111, 112.

Although modifications and changes may be suggested by those skilled in the art, it is the intention of the inventor to embody within the patent warranted hereon all changes and modifications as reasonably and properly come within the scope of his contribution to the art.

I claim as my invention:

1. A method for the assignment of a metadata entry to a medical image data record comprising:
providing a computer with a definition of a metadata class comprising a plurality of metadata entries characterizing features of medical image data;
providing said computer with a trained artificial neural network;
providing a medical image data record to be classified to said computer;
classifying the medical image data record in said computer using the trained artificial neural network according to an image content of the medical image data record, to produce a classification of the medical image data record with regard to the metadata class wherein one metadata entry among the plurality of metadata entries is assigned to the medical image data record; and
making an electronic signal representing said metadata class available as on output of said computer.

2. The method as claimed in claim 1, comprising selecting the metadata class from the group consisting of:
a body region depicted in the medical image data record;
an orientation of the medical image data record;
an imaging modality by means of which the medical image data record is recorded;
a protocol type by means of which the medical image data record is recorded; and
a type of image interference that occurs in the medical image data record.

3. The method as claimed in claim 1, comprising displaying the medical image data record with reference to the metadata entry assigned to the medical image data record on a display interface of a display monitor in communication with said computer.

4. The method as claimed in claim 3, wherein the display interface includes a plurality of display segments, and comprising selecting one display segment among the plurality of display segments with reference to the metadata entry assigned to the medical image data record, and displaying the medical image data record in the selected display segment.

5. The method as claimed in claim 3, wherein the display interface includes an input field for a user, and comprising displaying the medical image data record on the display interface with reference to a user input made by the user in the input field and to a comparison of the user input with the metadata entry assigned to the medical image data record.

6. The method as claimed in claim 1, comprising classifying multiple medical image data records using the trained artificial neural network, and assigning at least one metadata entry among the plurality of metadata entries respectively to each medical image data record among said multiple medical image data records, and performing a statistical evaluation of the plurality of medical image data records in said computer with reference to the metadata entries respectively assigned to the multiple medical image data records, and making an electronic signal that represents a result of the statistical evaluation available as an output of said computer.

7. The method as claimed in claim 6, wherein, during the classification of the multiple medical image data records, assigning a first metadata entry to a first set with a first number of first medical image data records among the multiple medical image data records, and assigning a second metadata entry is assigned to a second set with a second number of second medical image data records among the multiple medical image data records, and in the statistical evaluation, comparing the first number with the second number.

8. The method as claimed in claim 7, wherein the metadata class includes an occurrence of a specific type of image interference, and wherein the first metadata entry represents the occurrence of the specific type of image interference in the medical image data record and the second metadata entry represents an absence of the specific type of image interference in the medical image data record, and comprising compiling user information for a user with reference to the comparison of the first number with the second number.

9. A method for producing a trained artificial neural network comprising:
providing a computer with definition of a metadata class comprising a plurality of metadata entries characterizing features of medical image data
providing said computer with a plurality of training medical image data records;
in said computer, assigning metadata entries with respect to a metadata class to the plurality of training medical image data records;
training an artificial neural network in said computer using an image content of the plurality of training medical image data records and the metadata entries assigned to the plurality of training medical image data records, the trained artificial neural network facilitates assignment of a metadata entry to a medical image data record; and
making the trained artificial neural network available in said computer for classification of a medical image data record.

10. The method as claimed in claim 9, comprising training the artificial neural network by changing network parameters of the artificial neural network such that when the trained artificial neural network is applied to the image content of the plurality of training medical image data records, the artificial neural network allocates the metadata entries assigned to the plurality of training medical image data records to the plurality of training medical image data records.

11. The method as claimed in claim 9, comprising prior to the making the trained artificial neural network available in said computer, checking validity of the trained artificial neural network in said computer by determining metadata entries for part of the training medical image data records using the trained artificial neural network and comparing the determined metadata entries to the metadata entries assigned to a portion of the training medical image data records.

12. The method as claimed in claim 11, comprising excluding said portion of the medical image data records during the training of the artificial neural network.

13. The method as claimed in claim 9, comprising training the artificial neural network in a first training step and a second training step and, during the first training step, training the artificial neural network only on a basis of the image content of the plurality of training medical image data records by unsupervised learning and, during the second training step, refining the training in the artificial neural network performed in the first training step using the metadata entries assigned to the plurality of training medical image data records.

14. The method as claimed in claim 9, comprising assigning the metadata entries to the plurality of training medical image data records in a preprocessing step in said computer, in which the plurality of training medical image data records are processed by unsupervised learning.

15. The method as claimed in claim 14, comprising performing the unsupervised learning using at least one of a self-organizing-maps (SOM) method, and a t-stochastic neighborhood embedding (t-SNE) method.

16. The method as claimed in one of claim 14, comprising displaying the training medical image data records preprocessed in the preprocessing step to a user as a map, and allowing the user to assign the metadata entries to the plurality of training medical image data records by means of interaction with the map.

17. The method as claimed in claim 16, comprising allowing the user to assign the metadata entries to the plurality of training medical image data records on the map displayed using a graphical segmentation tool.

18. A computer for the assignment of a metadata entry to a medical image data record comprising:
an input interface configured to provide said computer with a definition of a metadata class comprising a plurality of metadata entries characterizing features of medical image data;
said input interface also being configured to provide said computer with a trained artificial neural network;
said input interface also being configured to provide a medical image data record to be classified to said computer;
a processor configured to classify the medical image data record using the trained artificial neural network according to an image content of the medical image data record, to produce a classification of the medical image data record with regard to the metadata class wherein one metadata entry among the plurality of metadata entries is assigned to the medical image data record; and
an output interface configured to make an electronic signal representing said metadata class available as on output of said computer.

19. A computer for producing a trained artificial neural network comprising:
an input interface configured to provide a computer with definition of a metadata class comprising a plurality of metadata entries characterizing features of medical image data
an input interface configured to provide said computer with a plurality of training medical image data records;
a processor configured to assign metadata entries with respect to a metadata class to the plurality of training medical image data records;
said processor being configured to train an artificial neural network using an image content of the plurality of training medical image data records and the metadata entries assigned to the plurality of training medical image data records, the trained artificial neural network facilitates assignment of a metadata entry to a medical image data record; and
an output interface configured to make the trained artificial neural network available for classification of a medical image data record.
